(19) United States
(12) Patent Application Publication
(10) Pub. No.: US 2002/0022095 A1
(43) Pub. Date: Feb. 21, 2002

(54) Panel using recycled film containers

(76) Inventor: Ji Oen Lee, Seoul (KR)

Correspondence Address: HUNTON AND WILLIAMS, 1900 K STREET N W, WASHINGTON, DC, 20006, US

(21) Appl. No.: 09/929,082

(22) Filed: Aug. 15, 2001

(30) Foreign Application Priority Data
Aug. 16, 2000 (KR) 20-0209449

(51) Int. Cl. B32B 1/02

(52) U.S. Cl. 428/34.1

(57) ABSTRACT

The present invention provides a light-weight panel incorporating recycled film containers for use as construction and other materials with enhanced sound and heat insulation qualities. The recycled film containers may be used as an internal material within a panel for maintaining a consistent thickness of the panel. The present invention further enhances waste recycling efforts and benefits the environment. The panel may include a first outer wall; a first portion adjacent to the first outer wall, the first portion having a plurality of grooves wherein each groove supports a recycled film container wherein each groove further comprises a blocked end of a substantially equal size as an outside diameter of each recycled film container; an interval maintenance tool for securely positioning each recycled film container in a predetermined position, the interval maintenance tool comprising a textile material and maintaining a regular interval between the recycled film containers; a second portion for covering the first portion; and a second outer wall adjacent to the second portion.

### CROSS-REFERENCE TO RELATED APPLICATIONS

This application claims priority to Korean patent application no. 20-0209449, filed on Aug. 16, 2000, which is hereby incorporated by reference.

### FIELD OF THE INVENTION

The present invention is related to a panel using recycled film containers, in particular, to a light-weight panel incorporating a plurality of recycled film containers wherein the light-weight panels may be used as construction and other materials for providing favorable sound and heat insulation qualities.

### BACKGROUND OF THE INVENTION

Generally, containers of various shapes and materials are collected and melted for recycling. However, due to a vast amount of recycled film containers, oftentimes recycled materials are not used effectively. Due to the lack of efficient use, greater amounts of industrial waste may be produced, as recycled products go unused.

Panels may serve various purposes in construction and other areas. Common uses may include walls, ceilings and other construction material. Panels may also serve as partitions in offices, homes and other areas by conveniently providing privacy.

Traditional panels generally use paper or glass fiber materials as an internal material for maintaining a predetermined panel thickness. However, after extended use and wear, these materials may not provide an adequate amount of strength and resilience. In addition, traditional materials contribute to additional environmental pollution after use.

Other drawbacks exist with current panel structures.

### SUMMARY OF THE INVENTION

The present invention provides a light-weight panel incorporating recycled film containers as an internal material for providing favorable sound and heat insulation qualities and further benefiting the environment.

The present invention provides a panel incorporating containers, wherein the panel comprises a first outer wall; a first portion adjacent to the first outer wall, the first portion having a plurality of grooves wherein each groove supports a recycled film container wherein each groove further comprises a blocked end of a substantially equal size as an outside diameter of each recycled film container; an interval maintenance tool for securely positioning each recycled film container in a predetermined position, the interval maintenance tool comprising a textile material and maintaining a regular interval between the recycled film containers; a second portion for covering the first portion; and a second outer wall adjacent to the second portion.

The panel of the present invention further comprises a filling agent wherein the filling agent comprises one or more of styrofoam, urethane foam and foamed concrete for unifying the first portion and the second portion. The panel may further comprise a plurality of lids for covering each recycled film container and for creating a space within each recycled film container. In addition, the textile material may comprise a wire net.

The present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

FIG. 1 is a sectional view illustrating an example of a panel according to an embodiment of the present invention.

FIG. 2 is a sectional view illustrating an example of a panel according to an embodiment of the present invention.

FIG. 3 is another view of a panel according to an embodiment of the present invention.

### DETAILED DESCRIPTION OF THE PREFERRED EMBODIMENTS

The present invention provides a light-weight panel incorporating recycled film containers as an internal material wherein favorable sound and heat insulation qualities may be realized. In addition, the panel of the present invention provides benefits to the environment as recycled products are efficiently and effectively used. In addition, compression strength provided by the light-weight panel of the present invention may conserve production and other costs.

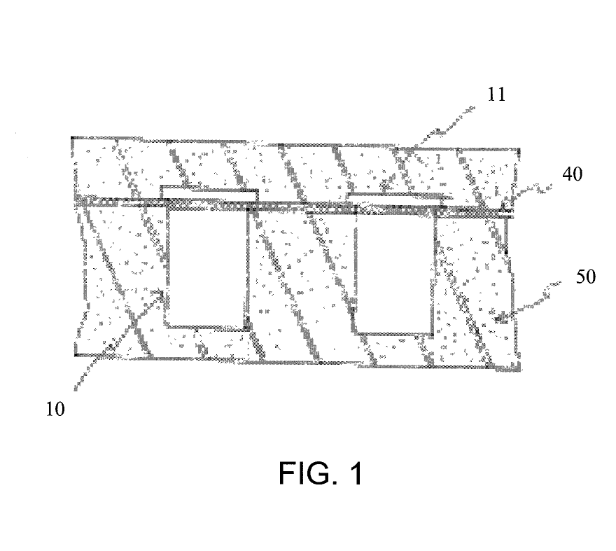

FIG. 1 is a sectional view illustrating an example of a panel according to an embodiment of the present invention. A light-weight panel may include a plurality of recycled film containers 10 for use as an internal material. The plurality of recycled film containers 10 may serve to provide support and maintain a consistent thickness of an overall panel structure. The light-weight panel of the present invention may provide improved sound and heat insulation. The improved qualities may be due to a plurality of empty spaces caused by the film containers. Empty spaces may be formed by an empty recycled film container 10 enclosed by a lid 11. A plurality of recycled film containers 10 may be supported by an interval maintenance tool 40, which may include a wire net or other similar material. Thus, a plurality of recycled film containers may be securely positioned periodically by the interval maintenance tool 40. The body of the panel may include a filling agent 50 for unifying the elements of the overall panel structure.

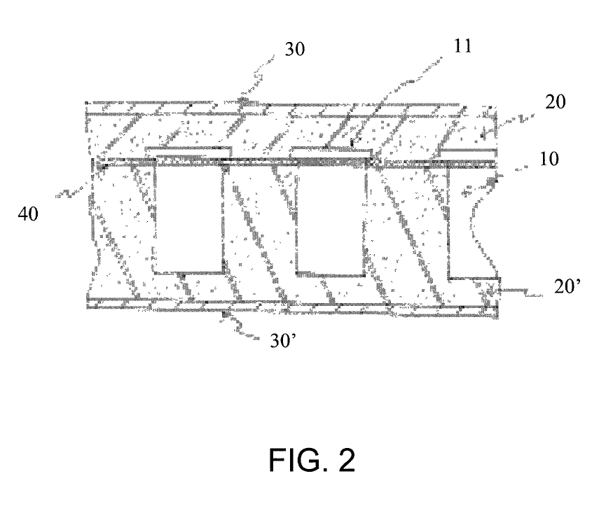

FIG. 2 is a sectional view illustrating an example of a panel according to an embodiment of the present invention. FIG. 2 shows a light-weight panel including a lower outer wall 30′, a lower portion 20′ formed adjacent to the lower outer wall 30′, a plurality of grooves formed in the lower portion 20′ for supporting a plurality of recycled film containers 10 wherein a lower blocked end of each groove may have a size similar to an outside diameter of a recycled film container, an upper portion 20; and an upper outer wall 30 positioned over the upper portion 20. In addition, the panel of the present invention may include an interval maintenance tool 40, e.g., a wire net, in which each recycled film container 10 may be inserted and fixed within the panel structure, e.g., a foam frame formed by a filling agent 50. The filling agent 50 may be used to provide a mold to unify an upper portion 20 and a lower portion 20′. The filling agent 50 may include one or more of styrofoam, urethane foam, foamed concrete or other material.

In another embodiment of the present invention, a recycled film container 10 may be positioned in a lower portion 20′ and covered by an upper portion 20, which may be combined together. Different types of outer wall 30, 30′ may be implemented to surround an internal panel structure. The material of the outer walls 30, 30′ may vary depending on various considerations, such as use, purpose, aesthetic preferences and other factors. The empty recycled film containers may be used as construction materials, e.g., walls, ceilings or floor materials, as well as partitions in offices, homes and other areas. The light-weight panel of the present invention incorporating a plurality of recycled film containers provides enhanced compression strengths, and improved sound and heat insulation qualities.

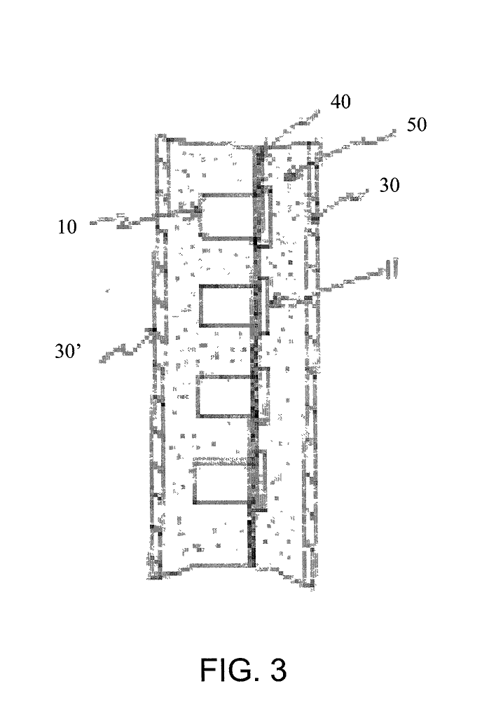

FIG. 3 is another view illustrating a light-weight panel, which may be utilized as a wall material, a partition in an area, such as an office, home or other purposes. According to another embodiment of the present invention, in order to strengthen a lateral angle of a light-weight panel, an interval maintenance tool 40 including a wire net or other textile material may be inserted between the upper portion 20 and the lower portion 20′.

Therefore, a light-weight panel incorporating recycled film containers according to the present invention may be used as construction and other materials, e.g., wall, floor materials, partitions in the offices, homes and other areas. The light-weight panel incorporating empty film containers enhances sound and heat insulation qualities and improves compression strength. Further, the light-weight panel of the present invention is economical because the light weight quality of the film containers improves workability, mobility and efficiency, thereby saving construction time and costs, and further minimizes environmental pollution.

While the invention has been shown and described with reference to certain preferred embodiments thereof, it will be understood by those skilled in the art that various changes in form and details may be made therein without departing from the spirit and scope of the invention as defined by the appended claims.

1. A panel incorporating containers, comprising:
a first outer wall;
a first portion adjacent to the first outer wall, the first portion having a plurality of grooves wherein each groove supports a recycled film container wherein each groove further comprises a blocked end of a substantially equal size as an outside diameter of each recycled film container;
an interval maintenance tool for securely positioning each recycled film container in a predetermined position, the interval maintenance tool comprising a textile material and maintaining a regular interval between the recycled film containers;
a second portion for covering the first portion; and
a second outer wall adjacent to the second portion.

2. The panel of claim 1, further comprising a filling agent wherein the filling agent comprises one or more of styrofoam, urethane foam and foamed concrete for unifying the first portion and the second portion.

3. The panel of claim 1, further comprising a plurality of lids for covering each recycled film container and for creating a space within each recycled film container.

4. The panel of claim 1, wherein the textile material comprises a wire net.
